(19) United States
(12) Patent Application Publication
(10) Pub. No.: US 2007/0103530 A1
(43) Pub. Date: May 10, 2007

(54) Suction or blowing cylinder

(75) Inventors: Herbert Schrefl, St. Poelten (AT); Harald Graf-Mueller, St. Margarethen/Raab (AT); Josef Kerschbaumer, Maria Lech (AT); Erwin Gutlederer, Melk (AT); Herbert Weinberger, Lilienfeld (AT); Franz Mueller, Obergrafendorf (AT); Thomas Hackl, Wilhelmsburg (AT)

Correspondence Address: GREENBLUM & BERNSTEIN, P.L.C., 1950 ROLAND CLARKE PLACE, RESTON, VA, 20191, US

(73) Assignee: VOITH PAPER PATENT GMBH, Heidenheim (DE)

(21) Appl. No.: 10/596,070

(22) PCT Filed: Nov. 9, 2004
(86) PCT No.: PCT/EP04/52892

§ 371 Date: Dec. 11, 2006

(30) Foreign Application Priority Data
Nov. 27, 2003 (DE) 103 55 427.0

(51) Int. Cl. B41J 2/01

(52) U.S. Cl. 347/102

(57) ABSTRACT

The invention relates to a suction or blowing cylinder of a machine which is used to produce and/or shape paper, cardboard, tissue or another fibrous material (2). Said cylinder comprises a rotatable, perforated cylinder covering (1) and at least one pressure area (4) which is connected to a lower pressure source or a high pressure source and is sealed in relation to the cylinder covering (1) with the aid of at least one sealing element (5, 6). The invention is characterised in that the sealing element (5, 6) is embodied in a flat-shaped manner and is arranged in the vicinity of the inner wall of the cylinder covering (1).

The invention relates to a suction or blowing cylinder of a machine for producing and/or shaping a paper, cardboard, tissue or another fibrous material, said cylinder comprising a rotatable, perforated cylinder covering and at least one pressure area which is connected to a low pressure source or a high pressure source and is sealed in relation to the cylinder covering with the aid of at least one sealing element.

### BACKGROUND OF THE INVENTION

Low or high pressure zones, which are embodied in the form of a pressure compartment connected to a low pressure source or a high pressure source and adjoining a moving surface such as the cylinder covering, are utilized in different locations of a machine for producing a web of fibrous material, in particular a paper machine, for example in the forming section, in the press section and/or in the drying section. The pressure compartments may be utilized, for instance, within suction cylinders. These usually comprise fixed internal suction compartments which form zones of different pressure levels, wherein sealing of the low pressure zones is accomplished by means of sealing elements, which, as a general rule, extend at least substantially along the complete length of the cylinder.

When the perforation on these cylinders gets out of the pressure area, the air pressure in the perforation and the outside pressure are equalized. As a result, air flows out of the perforation in the case of blowing cylinders and into the perforation in the case of suction cylinders. This air stream causes significant noise. Independently of that, air leaks in the region of the sealing elements can also lead to generation of noise.

To counter this noise, special sealing systems were developed in the area of the pressure compartment, which are, however, not sufficiently effective and/or too complex. A sealing system which prevents the generation of noise to a large extent is disclosed in DE 103 47 177.4.

In the known sealing system, an at least substantially air-tight cover, which runs in circumferential direction and is located outside of the pressure compartment, adjoins at least one sealing element or is located in the proximity of a side wall of the at least one pressure compartment on the outside of the cylinder covering, said cover making contact with the cylinder covering or being placed at a distance of less than 100 mm from the latter. The cover is either totally air tight or it allows air to pass through only to a small extent.

The known cover significantly prevents pressure equalization between the perforation and the inside of the cylinder. As a result, pressure equalization is essentially only possible with the external part of the cylinder or, depending on the design, essentially only possible with the inner part of the cylinder.

The sealing elements laterally separating the pressure compartment from the inner wall of the cylinder covering are constructed in the form of trims and pressed against the cylinder covering. The friction force generated between the sealing elements and the moving surface of the cylinder covering results in a high power requirement for driving the cylinder covering.

### SUMMARY OF THE INVENTION

It is the object of the present invention to provide a sealing device which reduces the friction force.

For a suction or blowing cylinder of the initially described type this object is achieved by the sealing element being embodied in a flat-shaped manner and being arranged in the vicinity of the inner wall of the cylinder covering.

As claimed in the invention, the trim-shaped sealing element, together with the cover adjacent thereto, is thus replaced by a flat-shaped sealing element; a reduction in driving power is achievable in this way.

Advantageous developments of the invention can be gathered from the sub-claims, the description and the drawings.

Of advantage is an embodiment of the plate-shaped sealing element wherein the distance between the inner wall of the cylinder covering and the sealing element is less than 1 mm.

The distance between the inner wall of the cylinder covering and the sealing element is less than 300 mm, preferably less than 50 mm.

Also of advantage is an embodiment of the invention wherein the distance between the inner wall of the cylinder covering and the sealing element is constant or it varies in axial direction and/or in circumferential direction (for example undulating).

It is advantageous when the sealing element extends in axial direction along the complete length of the suction or blowing cylinder or when it only extends along a partial length. In this case, the sealing element can also comprise a plurality of segments.

Further, the sealing element may extend in circumferential direction along the complete inner surface of the suction or blowing cylinder covering or along almost the complete inner surface of said covering.

The sealing element may be secured by fastening it to holding means provided in the vicinity of the inner surface of the suction or blowing cylinder covering. The holding means are themselves joined to a stationary axis in the center of the suction or blowing cylinder, or they are fastened to the front side.

In a further advantageous embodiment of the invention the sealing element is movably, in particular pivotably disposed in radial direction by means of at least one adjusting element.

The flat-shaped sealing elements provided, as claimed in the invention, instead of the trim-shaped sealing elements known in the state of the art, result in the vacuum area not being separated from the normal pressure zone, as usual, by narrow, short gaps, but by long gaps of limited width, instead. The sealing effect and the evacuation of the gaps between the sealing surfaces and the moving surface of the cylinder covering is achieved (in the case of the suction cylinder), in particular in the downward sealing area, by the residual vacuum in the open volumes and by the perforations of the moving surface, respectively. The long gaps of limited width can generate similar C_{w} values and thus a similar sealing effect as the usual short gaps. These statements also apply to a blowing cylinder. The application of the invention can result in a noticeable reduction in the driving power required for the moving surface as a result of reduced friction forces (because of lacking solid friction).

### BRIEF DESCRIPTION OF THE DRAWINGS

The invention will now be described by way of exemplary embodiments with reference to the accompanying drawings, in which:

FIG. 1: shows a schematic cross section of a suction cylinder comprising two sealing surfaces and

FIG. 2: shows the cross section of a suction cylinder comprising a single continuous sealing element.

### DETAILED DESCRIPTION OF THE INVENTION

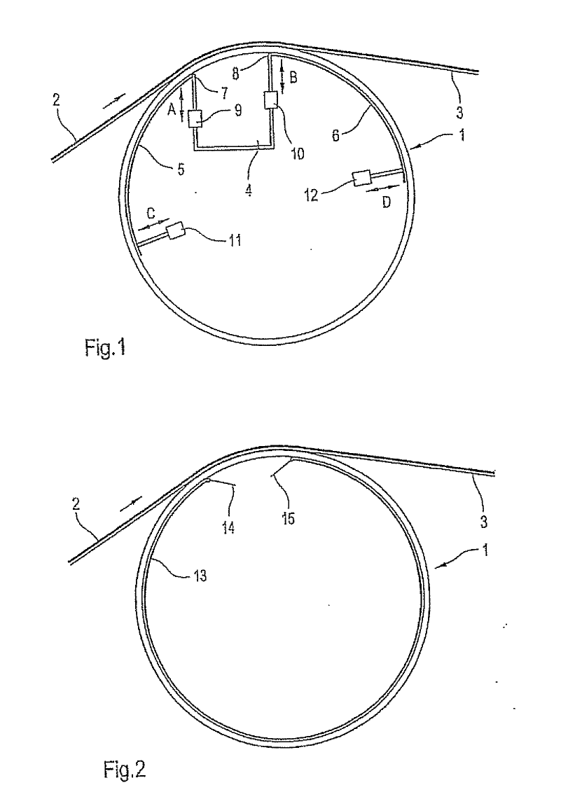

The cylinder is a suction cylinder having a rotatable cylinder covering 1 (FIG. 1) comprising open volumes, in particular perforations, the cylinder being like those utilized in paper machines, in particular in the sheet forming section, in the press section, and in the drying section.

The suction cylinder is embraced by an air-permeable belt 3, for example a screen or a felt or a belt consisting of another material, and by the web of fibrous material 2 located outside, wherein the embracing area is adjoined by a low pressure area within the cylinder, said area being formed by a fixed pressure compartment 4 which is open to the cylinder covering 1. The inside of the pressure compartment 4 is connected to a low pressure source.

To minimize air leakage, the pressure compartment 4 is connected from both sides to the sealing elements 5, 6, each of which preferably extends along large parts of the inner wall of the cylinder covering 1 without being in direct contact with it. The sealing elements 5, 6 cover, for example, one quarter or one third of the inner wall of the cylinder covering 1; however, in a further embodiment, they can also be only a few millimeters long.

The sealing elements 5, 6 are disposed at a preferably short distance, for example of less than one millimeter, from the cylinder covering 1, to prevent air leakage into the pressure compartment 4 as far as possible. The sealing elements 5, 6 are respectively connected to the pressure compartment 4 by means of holding means 7, 8.

The holding means 7, 8 extend, for example, in axial direction along the complete length of the suction cylinder 1 and are mounted at the front side. However, the holding means can also be mounted exclusively at the front side, so that the sealing elements 5, 6 are fastened in a “free floating” manner.

The sealing elements 5, 6 can, however, also be fastened to the holding means 7, 8 by means of joints to enable them to be pivoted.

Additionally or alternatively, it is provided that the sealing elements 5, 6 are fastened on adjusting elements 9, 10 and 11, 12, respectively. The sealing elements 5, 6 may be bent inwards from their respective ends by means of the adjusting elements 9 to 12 which are slidable in the direction of the double arrows A, B, C and D. The adjusting elements 9 to 12 are fastened, like the pressure compartment 4, to a (not shown) longitudinal axis or to the front side. Instead of the adjusting elements 9 to 12, adjusting elements may also be mounted on other locations of the sealing elements 5, 6.

In a further embodiment of the suction cylinder (FIG. 2) there is a single sealing element 13, which covers almost the entire inner wall of the cylinder covering and is fastened to the holding means 14, 15. Only the embracing area of the cylinder covering 1 comprising the web of fibrous material 2 is not covered with the sealing element 13, so that, as a result of the low pressure available in the entire inner area of the suction cylinder covered by the sealing element, moisture is withdrawn from the web of fibrous material 2 and/or the web of fibrous material 2 is pulled toward band 3.

For this reason, in this embodiment of the invention a separate pressure compartment is no longer required to provide a zone adjoining the embracing area with a low pressure zone within the suction cylinder. This embodiment in particular is thus characterized by the simplicity of its construction.

1. A suction or blowing cylinder of a machine for producing and/or shaping a paper, cardboard, tissue or another fibrous material (2), said cylinder comprising a rotatable, perforated cylinder covering (1) and at least one pressure area (4) which is connected to a low pressure source or a high pressure source and is sealed in relation to the cylinder covering (1) with the aid of at least one sealing element (5, 6; 13), characterized in that the sealing element (5, 6; 13) is embodied in a flat-shaped manner and is arranged in the vicinity of the inner wall of the cylinder covering (1).

2. The suction or blowing cylinder as claimed in claim 1, characterized in that the distance between the inner wall of the cylinder covering (1) and the sealing element is less than 1 mm.

3. The suction or blowing cylinder as claimed in claim 1, characterized in that the distance between the inner wall of the cylinder covering (1) and the sealing element (5, 6; 13) is less than 300 mm, preferably less than 50 mm.

4. The suction or blowing cylinder as claimed in claim 1, characterized in that the distance between the inner wall of the cylinder covering (1) and the sealing element (5, 6; 13) is constant or varies in axial direction and/or in circumferential direction.

5. The suction or blowing cylinder as claimed in claim 1, characterized in that the sealing element (5, 6; 13) extends in axial direction along the complete length of the suction or blowing cylinder or it only extends along a partial length.

6. The suction or blowing cylinder as claimed in claim 1, characterized in that the sealing element (13) extends in circumferential direction along the complete inner surface of the suction or blowing cylinder covering or along almost the complete inner surface of said covering.

7. The suction or blowing cylinder as claimed in claim 6, characterized in that the sealing element (5, 6; 13) is fastened to holding means (7, 8; 14, 15) provided in the vicinity of the inner surface of the suction or blowing cylinder covering.

8. The suction or blowing cylinder as claimed in claim 7, characterized in that the holding means (7, 8; 14, 15) are fastened to a fixed axis or to the front side.

9. The suction or blowing cylinder as claimed in claim 1, characterized in that the sealing element (5, 6) is movably, in particular pivotably disposed in radial direction by means of at least one adjusting element (9, 10, 11, 12).
